(19) United States
(12) Patent Application Publication
(10) Pub. No.: US 2003/0162455 A1
(43) Pub. Date: Aug. 28, 2003

(54) Woody decorative item and method of manufacturing same

(75) Inventor: Yoshiaki Sano, Shizuoka-ken (JP)

Correspondence Address: CROWELL & MORING LLP, INTELLECTUAL PROPERTY GROUP, P.O. BOX 14300, WASHINGTON, DC, 20044-4300, US

(73) Assignee: Kabushiki Kaisha Kawai Gakki Seisakusho, Hamamatsu-shi (JP)

(21) Appl. No.: 10/354,965

(22) Filed: Jan. 31, 2003

(30) Foreign Application Priority Data
Feb. 26, 2002 (JP) 049501/2002

(51) Int. Cl. B32B 5/08; B28B 5/00; B32B 5/26

(52) U.S. Cl. 442/269; 428/537.1; 442/286; 264/241

(57) ABSTRACT

A woody decorative item features in that a sliced veneer sheet can be free from a change in shape and dimensions even with an aqueous adhesive and hence handled with ease, and an improved anchoring effect permits the sliced veneer sheet to be securely bonded to a base. The woody decorative item comprises a sliced veneer, an unwoven fabric adhered on the back of the sliced veneer, a woven fabric adhered on the unwoven fabric, and a base made of a synthetic resin and bonded on the back of the sliced veneer through the woven fabric. A method of manufacturing the woody decorative item comprises the steps of providing the sliced veneer, sequentially adhering the unwoven fabric and woven fabric on the back of the sliced veneer with pressure to fabricate the sliced veneer sheet, setting the sliced veneer sheet in a mold, supplying a synthetic resin on the back of the sliced veneer sheet in the mold to form a base thereon, and pressing the base against the sliced veneer sheet for integration.

### BACKGROUND OF THE INVENTION

1. Field of the Invention

The present invention relates to a woody decorative item comprised of a sliced veneer arranged on the front side and a base made of synthetic resin and arranged on the back side, for use in interior parts of vehicles, furniture, home electric appliances and the like.

2. Description of the Prior Art

A conventional woody decorative item of the type mentioned above is illustrated in FIG. 1. The illustrated woody decorative item 11 comprises a sliced veneer 13 on the front side; an unwoven fabric 14 adhered on the back of the sliced veneer 13; and a base 15 integrally attached to the back of the unwoven fabric 14. The sliced veneer 13 is coated with a top coating layer 12 on the surface.

The sliced veneer 13, made of sliced wood such as maple, functions as a decorative layer of the woody decorative item 11. The unwoven fabric 14 reinforces the sliced veneer 13 which is susceptible to cracking. The base 15, made of synthetic resin, ensures the strength and rigidity of the woody decorative item 11. The top coating layer 12, made of transparent polyester paint or the like, shines and protects the surface of the woody decorative item 11.

The woody decorative item 11 in the foregoing structure is manufactured, for example, in the following manner. First, a sheet applied bedplate (not shown) is provided. The bedplate comprises a thick flat plate, and a vinyl chloride sheet adhered on the surface of the flat plate. Next, an adhesive is applied on the surface of the bedplate, and the unwoven fabric 14 is placed on the surface of the bedplate. After an adhesive is applied on the surface of the unwoven fabric 14, the sliced veneer 13 is placed on the unwoven fabric 14 for adhesion thereto. It should be noted that when an aqueous adhesive is used for the adhesion, the sliced veneer 13, curled or shrunk during drying, may promote a change in shape and dimensions of a sliced veneer sheet 16 which consequently becomes difficult to handle. To avoid this inconvenience, the vinyl chloride sheet of the bedplate restricts the unwoven fabric 14 to prevent the sliced veneer sheet 16 from changing in shape and dimensions. After the sliced veneer sheet 16 is peeled off the vinyl chloride sheet of the bedplate, the sliced veneer sheet 16 is integrated with the synthetic resin which comprises the base 15 through injection molding or the like. Next, the top coating layer 12 is formed on the surface of the sliced veneer 13, thus completing the woody decorative item 11.

In the method of manufacturing the conventional woody decorative item 11, the adhesive for adhering the sliced veneer sheet 16 on the bedplate remains on the back of the sliced veneer sheet 16 during injection molding. Since the sliced veneer sheet 16 and base 15 are integrally molded in this state, the remaining adhesive hinders an anchoring effect between the unwoven fabric 14 of the sliced veneer sheet 16 and the base 15, resulting in a failure in securely bonding them to each other. Consequently, the sliced veneer sheet 16 is more likely to peel off or rise from the base 15 when a shear force is applied between the unwoven fabric 14 and base 15 due to a change in temperature or humidity, or an external force applied thereto during assembly.

### SUMMARY OF THE INVENTION

In view of the foregoing, it is an object of the invention to provide a woody decorative item which is capable of solving the problem mentioned above. Specifically, even with an aqueous adhesive, a sliced veneer sheet can be free from a change in shape and dimensions and hence handled with ease, and an improved anchoring effect permits the sliced veneer sheet to be securely bonded to a base.

It is another object of the present invention to provide a method of manufacturing the woody decorative item described above.

To achieve the first object, the present invention provides a woody decorative item which is characterized by comprising a sliced veneer; an unwoven fabric adhered on the back of the sliced veneer; a woven fabric adhered on the unwoven fabric; and a base made of a synthetic resin and bonded on the back of the sliced veneer through the woven fabric.

This woody decorative item has the woven fabric adhered on the back of the sliced veneer reinforced by the unwoven fabric. The woven fabric thus adhered restricts the unwoven fabric to prevent deformation thereof, so that the unwoven fabric is free from breakage or shrink and prevented from a change in shape and dimensions before the sliced veneer sheet comprised of the sliced veneer, unwoven fabric and woven fabric is bonded to the base. In addition, the base can be directly bonded to the woven fabric without any adhesive remaining on the back of the woven fabric. Consequently, a large anchoring effect is ensured to permit secure bonding of the sliced veneer sheet to the base. It is therefore possible to prevent the sliced veneer sheet from peeling off or rising from the base.

Preferably, in the woody decorative item, the woven fabric is made of a natural fiber.

According to this preferred embodiment of the woody decorative item, the woven fabric is made of a natural fiber such as cotton, by way of example, which is more nappy on the surface than a synthetic resin fiber. The miniature ruggedness on the surface of the woven fabric is brought into secure engagement with the base, when the base is integrated with the sliced veneer sheet, to ensure a larger anchoring effect, thereby making it possible to more securely bond the base to the sliced veneer sheet.

To achieve the second object, the present invention provides a method of manufacturing a woody decorative item. The method is characterized by comprising the steps of providing a sliced veneer; sequentially adhering an unwoven fabric and a woven fabric on the back of the sliced veneer with pressure to fabricate a sliced veneer sheet; setting the sliced veneer sheet in a mold; supplying a synthetic resin on the back of the sliced veneer sheet in the mold to form a base thereon; and pressing the base against the sliced veneer sheet for integration.

This manufacturing method can readily manufacture the aforementioned woody decorative item by advancing the formation simultaneously with the integration of the sliced veneer sheet with the base, and provide the aforementioned advantages of the woody decorative item. An adhesive for use in bonding the unwoven fabric and woven fabric to the sliced veneer may be an inexpensive aqueous adhesive, for example, a melanin-urea based adhesive, thereby reducing the manufacturing cost.

### BRIEF DESCRIPTION OF THE DRAWINGS

FIG. 1 is a schematic cross-sectional view illustrating an example of a conventional woody decorative item;

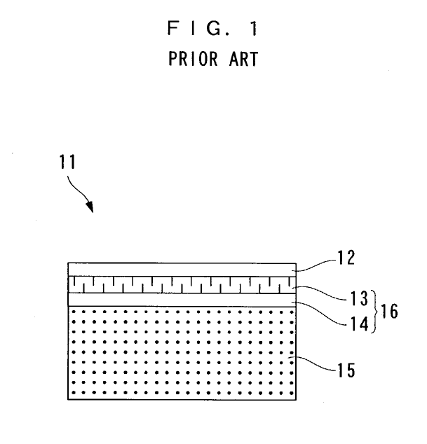

FIGS. 2A to 2C are diagrams illustrating a method of manufacturing a sliced veneer sheet forming part of a woody decorative item according to a first embodiment of the present invention;

FIGS. 3A to 3C are diagrams illustrating remaining steps of the method of manufacturing the woody decorative item in FIG. 2;

FIGS. 4A to 4D are diagrams illustrating a method of manufacturing a sliced veneer sheet forming part of a woody decorative item according to a second embodiment of the present invention; and

FIGS. 5A to 5D are diagrams illustrating a method of manufacturing a sliced veneer sheet forming part of a woody decorative item according to a third embodiment of the present invention.

### DETAILED DESCRIPTION OF THE PREFERRED EMBODIMENTS

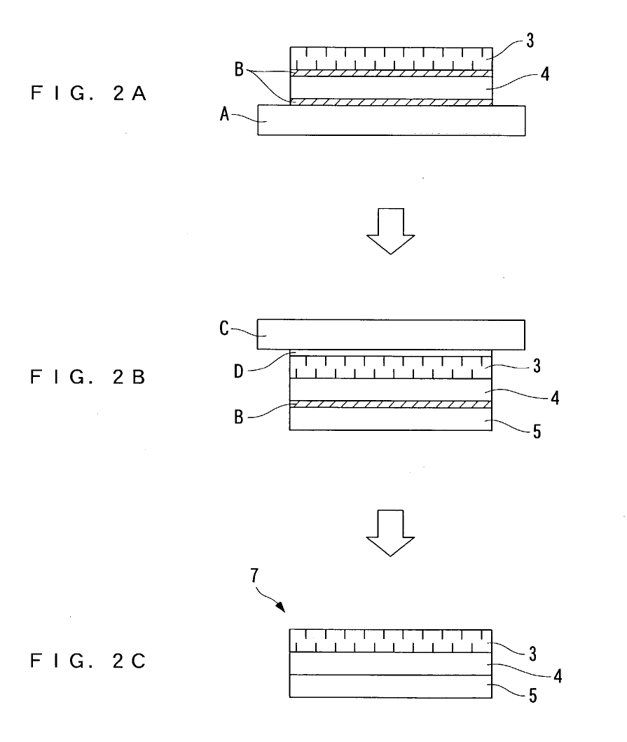

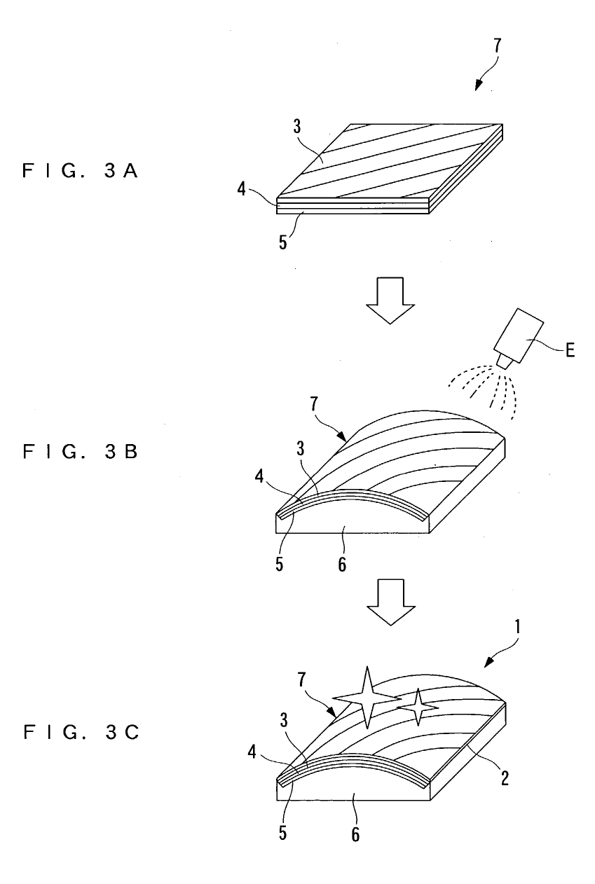

In the following, preferred embodiments of the present invention will be described in detail with reference to the accompanying drawings. FIGS. 2 and 3 illustrate a woody decorative item 1 according to a first embodiment of the present invention, and a method of manufacturing the same. As illustrated in FIG. 3C, the woody decorative item 1 comprises a sliced veneer 3 on the front side; an unwoven fabric 4 and a woven fabric 5 adhered on the back of the sliced veneer 3; and a base 6 integrally molded on the back of the woven fabric 5. A top coating layer 2 is formed on the surface of the sliced veneer 3.

The sliced veneer 3 provides the woody decorative item 1 with a decorative effect, and is formed by slicing solid wood such as maple, walnut or the like into a plate of approximately 0.2 mm thick.

The unwoven fabric 4 reinforces the sliced veneer 3 which is susceptible to cracking. The woven fabric 5 reinforces the unwoven fabric 4 to prevent the same from deforming due to breakage or shrink, as well as functions as an anchoring layer when the base 6 is bonded through injection molding for integration. In the first embodiment, the unwoven fabric 4 is made of a thin polyester or vinylon sheet having a thickness of approximately 0.1 mm, while the woven fabric 5 is made of a cotton sheet having a thickness of approximately 0.2 mm.

The base 6 adds the strength and rigidity to the woody decorative item 1, and is formed much thicker than other components. In the first embodiment, the base 6 is molded integrally with a sliced veneer sheet 7 through injection molding, so that the base 6 is made of synthetic resin suitable for the injection molding and excellent in strength, heat resistance, and dimension stability, for example, ABS, polycarbonate, or the like.

The top coating layer 2, which may be a transparent polyester paint, protects the surface of the woody decorative item 1. In addition, the top coating layer 2 is burnished to give the woody decorative item 1 an upscale image.

Next, a method of manufacturing the woody decorative item 1 will be described with reference again to FIGS. 2A to 2C. Generally, the unwoven fabric 4 and woven fabric 5 are adhered to the sliced veneer 3 to fabricate the sliced veneer sheet 7.

Specifically, first, a bedplate A having a vinyl chloride sheet (not shown) adhered on a surface, for example, is provided as illustrated in FIG. 2A. The unwoven fabric 4 is set at a predetermined position on the surface of the bedplate A. In this event, an adhesive B is applied between the bedplate A and unwoven fabric 4 for preventing the unwoven fabric 4 from shifting. Next, the sliced veneer 3 is set on the surface of the unwoven fabric 4 in register. In this event, the adhesive B is also applied between the sliced veneer 3 and unwoven fabric 4 for adhesion of one to the other. The adhesive B may be a melanin-urea based aqueous adhesive which is inexpensive and has a thermo-setting property. Next, the resulting laminate is hot-pressed from the surface of the sliced veneer 3, causing the adhesive B to cure to integrate the sliced veneer 3 with the unwoven fabric 4. Then, the integrated sliced veneer 3 and unwoven fabric 4 are peeled off the bedplate A. Since the vinyl chloride sheet is applied on the surface of the bedplate A, they can be readily peeled off the bedplate A.

In the next step, as illustrated in FIG. 2B, the surface of the sliced veneer 3 is set at a predetermined position on a bedplate C through a double-sided adhesive tape D for preventing the sliced veneer 3 from shifting. The woven fabric 5 is also set on the back of the unwoven fabric 4 in register. In this event, the adhesive B identical in type to the foregoing is applied between the unwoven fabric 4 and woven fabric 5 for adhesion of one to the other. The resulting laminate is hot-pressed from the back of the woven fabric 5, causing the adhesive B to cure to integrate the unwoven fabric 4 with the woven fabric 5. Then, the bedplate C and double-sided adhesive tape D are removed to complete the sliced veneer sheet 7 illustrated in FIG. 2C which has the sliced veneer 3, unwoven fabric 4 and woven fabric 5 integrated with each other.

Before fabricating the sliced veneer sheet 7, the sliced veneer 3 may be bleached or dyed. The bleaching, causing the color to become lighter, reduces color variations on the sliced veneer 3. The dying, in turn, facilitates adjustments of the hue of the sliced veneer 3. A combination of the bleaching and dying provides the sliced veneer 3 with uniform color and desired hue.

Next, the fabricated sliced veneer sheet 7 (FIG. 3A) is set in a mold (not shown), and molten synthetic resin is injected onto the back of the sliced veneer sheet 7 to integrate the base 6 on the back of the sliced veneer sheet 7 and form the entirety into a predetermined shape (FIG. 3B). Finally, the top coating layer 2 is applied on the surface of the sliced veneer 3 using a painter E, thus completing the woody decorative item 1 (FIG. 3C).

As described above, according to the woody decorative item 1 of the first embodiment, no adhesive B is applied between the sliced veneer sheet 7 and the base 6 adhered on the back thereof, so that they can be securely bonded to each other because the anchoring effect is not hindered. The woven fabric 5 directly bonded to the base 6 is made of cotton, which is a natural fiber, having miniature ruggedness on the surface. When the base 6 is integrated with the sliced veneer sheet 7 through injection molding, the molten synthetic resin introduces into the ruggedness, cooled down, and cured, thereby ensuring a larger anchoring effect between the woven fabric 5 and base 6. Thus, the base 6 can be more securely bonded to the woven fabric 5. Consequently, the sliced veneer sheet 7 can be prevented from peeling off or rising from the base 6, and from relatively shifting from the base 6, even if a large shear force is applied to the bonding face of the base 6 to the sliced veneer sheet 7 due to a change in temperature or humidity, or an external force possibly acting during assembly.

Since the unwoven fabric 4 is reinforced and prevented from deformation by the woven fabric 5 further adhered on the back of the sliced veneer 3 reinforced by the unwoven fabric 4, the sliced veneer sheet 7 can be prevented from a change in shape and dimensions even when the adhesive B is an aqueous adhesive. Consequently, the sliced veneer sheet 7 can be readily handled.

Further, in the first embodiment, the sliced veneer 3 reinforced by the unwoven fabric 4 and woven fabric 5 can eliminate or reduce the influence exerted by the anisotropy inherently possessed thereby due to the fact that the sliced veneer 3 is a woody material, so that the woody decorative item 1 can be prevented from bowing and twisting. The top coating layer 2 formed on the surface of the sliced veneer 3 increases the smoothness on the surface of the woody decorative item 1 to provide a better result, as well as protects the surface of the woody decorative item 1 to increase the durability.

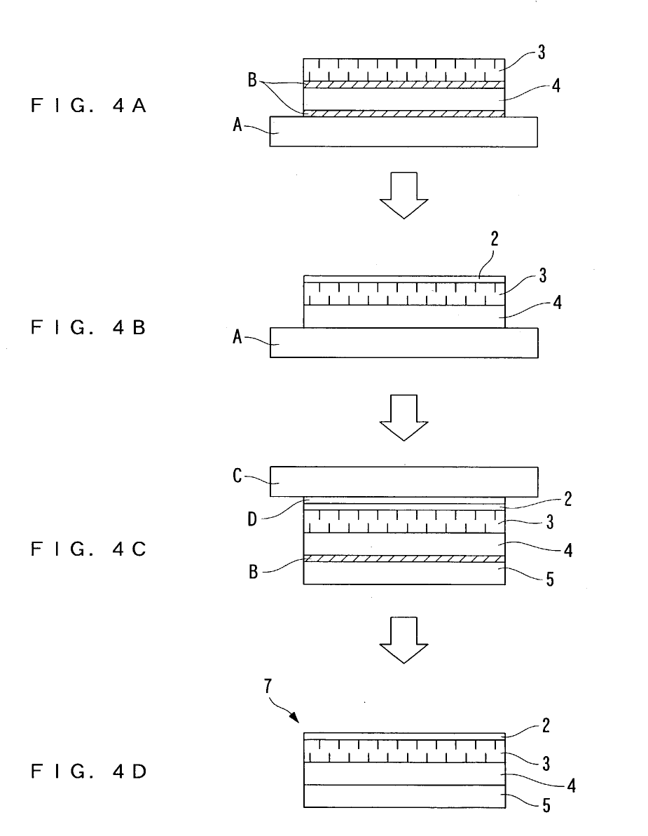

FIGS. 4A to 4D illustrate a method of manufacturing the sliced veneer sheet 7 forming part of the woody decorative item 1 according to a second embodiment of the present invention. First, as illustrated in FIG. 4A, the sliced veneer 3 and unwoven fabric 4 are pressed for integration in a manner similar to the first embodiment. Then, the top coating layer 2 is applied on the surface of the sliced veneer 3 (FIG. 4B). In this manner, the sliced veneer 3 can be applied with the top coating layer 2 while it is adhered on the surface of the bedplate A together with the unwoven fabric 4, i.e., while the sliced veneer 3 is held flat by the bedplate A, so that the top coating layer 2 can be uniformly formed on the sliced veneer 3 without variations. It is therefore possible to form the better finished top coating layer 2 than that of the first embodiment which is applied with the top coating layer 2 after the base 6 is integrated with the sliced veneer sheet 7 through injection molding and the entirety is formed into a predetermined shape. In addition, when the top coating layer 2 is applied on the sliced veneer 3 after the injection molding, it is typical that the top coating layer 2 must be formed on a curved surface with increased efforts due to manual operations required for the coating and subsequent polishing. On the other hand, according to the second embodiment, the top coating layer 2 can be efficiently applied on the flat sliced veneer 3 by a flow coater, not shown, or the like, thereby largely reducing steps involved in the coating. The subsequent steps are similar to the first embodiment in that the sliced veneer sheet 7 is fabricated with the top coating layer 2 previously formed on the sliced veneer 3 (FIGS. 4C, 4D), and the base 6 is integrated with the sliced veneer sheet 7 through injection molding to complete the woody decorative item 1.

As described above, the method of manufacturing the woody decorative item 1 according to the second embodiment provides similar advantages to those of the first embodiment, the better finished top coating layer 2, and a large reduction in manufacturing steps.

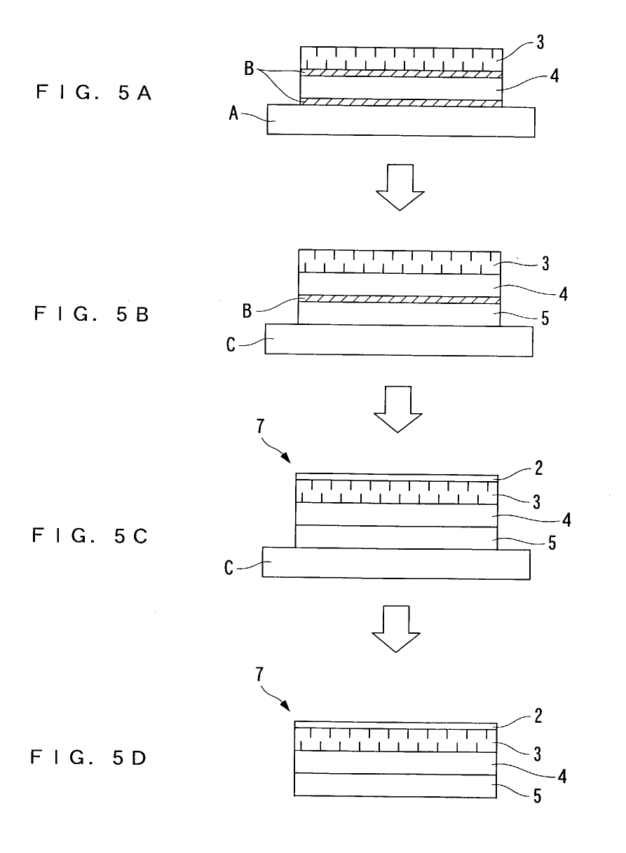

FIGS. 5A to 5D illustrate a method of manufacturing the sliced veneer sheet 7 forming part of the woody decorative item 1 according to a third embodiment of the present invention. First, as illustrated in FIG. 5A, the sliced veneer 3 and unwoven fabric 4 are pressed for integration on the surface of the bedplate A in a manner similar to the first embodiment. Next, as illustrated in FIG. 5B, another bedplate C is provided, and the woven fabric 5 is set at a predetermined position on the surface of the bedplate C. Further, the integrated sliced veneer 3 and unwoven fabric 4 are set on the surface of the woven fabric 5 in register. In this event, the adhesive B is applied between the woven fabric 5 and unwoven fabric 4 for adhesion of one to the other, and the woven fabric 5 is temporarily fixed on the bedplate C, for example, through a double-sided adhesive tape (not shown) for preventing a shift without adhesive. Alternatively, the woven fabric 5 may be temporarily fixed on the bedplate C by any mechanical means instead of the double-sided adhesive tape, without adhesive. The resulting laminate is hot-pressed from the surface side of the sliced veneer 3, thereby causing the adhesive B to cure to integrate the unwoven fabric 4 with the woven fabric 5. Thus, the sliced veneer sheet 7 is fabricated.

Subsequently, with the sliced veneer sheet 7 fixed on the bedplate C, the top coating layer 2 is applied on the surface of the sliced veneer 3 (FIG. 5C). In this event, the sliced veneer 3 maintained flat permits the formation of the well finished top coating layer 2, as is the case with the second embodiment. Then, the sliced veneer sheet 7 is peeled off the bedplate C (FIG. 5D), and the base 7 is integrated with the sliced veneer sheet 7 through injection molding in a manner similar to the first embodiment, to complete the woody decorative item 1. As appreciated from the foregoing, the method of manufacturing the woody decorative item 1 according to the third embodiment provides similar advantages to those of the second embodiment. Specifically, the third embodiment provides similar advantages to those of the first embodiment, the better finished top coating layer 2, and a large reduction in manufacturing steps.

While the foregoing embodiments rely on the injection molding in forming the woody decorative item 1 and integrating the sliced veneer 3 with the base 6, these steps can be carried out by another suitable pressure forming method, for example, vacuum forming, hot pressing, cold pressing, or the like. Also, it should be understood that the materials shown in the embodiments for the sliced veneer, unwoven fabric and woven fabric are illustrative in any sense, and other suitable materials may be employed as appropriate. Particularly, the woven fabric is not limited to cotton shown in the embodiments, but may be another natural fiber or synthetic resin fiber. Further, while the sliced veneer sheet 7 is fabricated by two-step hot pressing as illustrated in FIGS. 2A, 2B in the foregoing embodiments, the sliced veneer sheet 7 may be fabricated by single hot pressing as long as the sliced veneer sheet 7 can be directly bonded to the base 6 without leaving an adhesive or the like on the back of the woven fabric 5. Otherwise, details in the structure may be modified as appropriate without departing from the spirit and scope of the invention.

As described above in detail, the woody decorative item according to the present invention is advantageous in that a sliced veneer sheet can be free from a change in shape and dimensions even with an aqueous adhesive and hence handled with ease, and an improved anchoring effect permits the sliced veneer sheet to be securely bonded to a base.

What is claimed is:

1. A woody decorative item comprising:
a sliced veneer;
an unwoven fabric adhered on the back of said sliced veneer;
a woven fabric adhered on said unwoven fabric; and
a base made of a synthetic resin and bonded on the back of said sliced veneer through said woven fabric.

2. A woody decorative item according to claim 1, wherein said woven fabric is made of a natural fiber.

3. A method of manufacturing a woody decorative item comprising the steps of:
providing a sliced veneer;
sequentially adhering an unwoven fabric and a woven fabric on the back of said sliced veneer with pressure to fabricate a sliced veneer sheet;
setting said sliced veneer sheet in a mold;
supplying a synthetic resin on the back of said sliced veneer sheet in said mold to form a base thereon; and
pressing said base against said sliced veneer sheet for integration.
